(19) United States
(12) Patent Application Publication
(10) Pub. No.: US 2026/0280984 A1
(43) Pub. Date: Sep. 17, 2026

(54) METHOD OF MODEL DATASET SIGNALING FOR RADIO ACCESS NETWORK

(71) Applicant: Continental Automotive Technologies GmbH, Hannover (DE)

(72) Inventors: Hojin KIM, Regensburg (DE); Rikin SHAH, Langen, Hessen (DE); David GONZALEZ GONZALEZ, Egelsbach, Hessen (DE); Shravan Kumar KALYANKAR, Singapore (SG)

(73) Assignee: Continental Automotive Technologies GmbH, Hannover (DE)

(21) Appl. No.: 19/470,544

(22) PCT Filed: Mar. 27, 2024
(86) PCT No.: PCT/EP2024/058317

§ 371 Date: Sep. 29, 2025

(30) Foreign Application Priority Data
Apr. 5, 2023 (DE) 10 2023 203 189.2

(51) Int. Cl. H04L 41/0853; H04L 41/16

(52) U.S. Cl. CPC H04L 41/0853; H04L 41/16

(57) ABSTRACT

The present application describes methods of transferring AI/ML based model dataset or subset in wireless mobile communication system including base station (e.g., gNB) and mobile station (e.g., UE). The dataset index or the subset from the collected dataset is sent for dataset transfer event wherein the dataset mapping table is maintained in repository and/or the original dataset collection is divided into multiple subsets based on the measured dataset characteristics.

### CROSS REFERENCE TO RELATED APPLICATIONS

This application is the U.S. National Phase Application of PCT International Application No. PCT/EP2024/058317, filed Mar. 27, 2024, which claims priority to German Patent Application No. 10 2023 203 189.2, filed Apr. 5, 2023, the contents of such applications being incorporated by reference herein.

### TECHNICAL FIELD

The present disclosure relates to AI/ML based model dataset transfer, where techniques for pre-configuring and signaling the specific information about mapping relationship information using association between models and other index values for the dataset transfer are presented.

### BACKGROUND OF THE INVENTION

In 3GPP, one of the selected study items as the approved Release 18 package is AI/ML (artificial intelligence/machine learning) as described in the related document (RP-213599) addressed in 3GPP TSG RAN meeting #94e. The official title of AI/ML study item is “Study on AI/ML for NR Air Interface”, incorporated herein by reference, and currently RAN WG1 and WG2 are actively working on specification. The goal of this study item is to identify a common AI/ML framework and areas of obtaining gains using AI/ML based techniques with use cases.

According to 3GPP, the main objective of this study item is to study AI/ML framework for air-interface with target use cases by considering performance, complexity, and potential specification impact. In particular, AI/ML model, terminology and description to identify common and specific characteristics for framework will be one of key work scope. Regarding AI/ML framework, various aspects are under consideration for investigation and one of key items is about lifecycle management of AI/ML model where multiple stages are included as mandatory for model training, model deployment, model inference, model monitoring, model updating etc.

Earlier, in 3GPP TR 37.817 for Release 17, titled as Study on enhancement for Data Collection for NR and EN-DC, incorporated herein by reference, UE mobility was also considered as one of AI/ML use cases and one of scenarios for model training/inference is that both functions are located within RAN node. Followingly, in Release 18 the new work item of “Artificial Intelligence (AI)/Machine Learning (ML) for NG-RAN” was initiated to specify data collection enhancements and signaling support within existing NG-RAN interfaces and architecture.

For the above active standardization works, currently there is no definition for signaling methods or gNB-UE behaviors about supporting AI/ML model dataset transfer. In 3GPP RAN 1#110 bis-e meeting, it was concluded to consider three types of two-sided model training (e.g., Type-1,-2,-3) wherein some scenarios require full dataset transfer from one side to the other so that both NW-side and UE-side models can be matched as pair for ML operation. However, in this case the drawback is to send the collected dataset to train both models with the common data samples. In addition, using the mismatched dataset on both sides might result in model performance degradation when only partial dataset is used without data sample control. Based on the above, it is observed that transmission of model dataset collection can put significant impact on signaling overhead and resource occupancy between gNB and UE depending on diverse ML operation use cases. As a result, procedure and signaling between gNB and UE need to be specified to support AI/ML model dataset transfer.

US 2017372232A1 and US2021357699A1, each incorporated herein by reference, describe how to identify one or more data quality issues in machine learning training data.

US2020374305A1, incorporated herein by reference, shows a real-time data quality check for online machine learning system.

US2021357795A1, incorporated herein by reference, shows how to generate the predicted dataset.

US2022138561A1, incorporated herein by reference, explains about data filter for the refined training data.

US2022277221A1, incorporated herein by reference, shows how to generate the expert labels.

US2022414464A1, incorporated herein by reference, considers federated machine learning for multiple data quality based sources.

US2023039828A1, incorporated herein by reference, also shows data quality control method.

US20170244969A1, incorporated herein by reference, describes about extraction of feature amount.

A method of model dataset signaling for radio access network sending the dataset index or the data subset from the collected dataset for dataset transfer from one node to the other node, where the matched dataset index is sent based on the valid dataset mapping table the following steps are performed:

Dataset based mapping relationship information are stored in dataset repository in network side and shared with UEs. UE generates dataset collection for UE-side model operation. UE searches and identifies the specific dataset index matched with the collected dataset. The matched dataset index is sent to gNB for network-side model operation. The prioritized subset of the collected dataset is sent based on the data sample quality, whereby the collected dataset is split into two or more multiple data subsets based on the pre-configured data samples with different quality thresholds. Data subset(s) selected with target quality is used for UE-side model. The same data subset(s) is sent to gNB for network-side model operation. Dataset collection is processed by UE side first, wherein the method can happen when dataset collection is firstly processed by network side.

In some embodiments of the method according to the first aspect, the method is characterized by, that dataset based mapping relationship information is a mapping tables which are stored in dataset repository in network side and shared with UEs through RRC signaling.

In some embodiments of the method according to the first aspect, the method is characterized by, that the associated parameters are sent together when sending data sample set where the candidate associated information includes indication of dataset mapping table version, dataset index, statistical characteristic information with data quality threshold level for the selected data subset(s), data subset size index, depending on dataset transmission methods, any combination of the above associated parameters can be transmitted together whereby this signaling flow is based on UE-to-gNB and also gNB-to-UE is done in a similar way.

In some embodiments of the method according to the first aspect, the method is characterized by that the data sample set is a data subset, and/or full dataset and/or compressed dataset and/or synthetic data.

In some embodiments of the method according to the first aspect, the method is characterized by that UE firstly receives assistance information from gNB about configuration information related to dataset collection when dataset collection firstly happens on UE side where. Regarding configuration information, it can include model-specific configuration, dataset characteristics, threshold parameters for dataset collection or subset categorization. If dataset mapping table is available and there is any matched dataset index available compared with the collected dataset, UE can send the index information and/or synthetic data without sending the collected dataset itself. Alternatively, when there is no matched dataset index for selection based on dataset mapping table, UE can select the prioritized data subset from the collected dataset as full set so that signaling overhead can be reduced.

In some embodiments of the method according to the first aspect, the method is characterized by using different dataset characteristics with associated attribute data categories, dataset can be generated with index values through offline model operation where depending on different service or applications for AI/ML model use, there can be different number of tables for dataset mapping relationship that can be stored in dataset repository. The associated data content (e.g., attribute data categories) include data characteristics (e.g., statistical information), model configuration (e.g., model type, model parameters), operation environment (e.g., site/time/device information).

In some embodiments of the method according to the first aspect, the method is characterized by sorting out data subset(s) matched with target sample quality, the full set of the collected dataset can be divided into qualified dataset and non-qualified dataset based on the pre-configured data quality measure with target quality threshold for ML operation-specific requirement related to different implementation use cases.

In some embodiments of the method according to the first aspect, the method is characterized by mapping of reference datasets with other data values is into a finite set of data subsets where based on the collected dataset, mapping relationship of quality-based dataset index is generated. Multiple mapping tables can be managed through repository for different model use cases based on online/offline and/or LCM phases (training, inferencing, monitoring).

In some embodiments of the method according to the first aspect, the method is characterized by that multiple data subsets transfer where Multiple data subsets are transmitted until there is request message to stop sending dataset. Based on model operation status with the received data subsets, request message to stop sending dataset is sent and the associated model status information is sent together. Response message to confirm dataset transfer completion is sent back. This signaling flow can happen for UE-to-gNB and gNB-to-UE scenarios.

In some embodiments of the method according to the first aspect, the method is characterized by that the dataset-based UE grouping gNB collects the indexed value of dataset (subset) from UEs using statistical information of dataset where UEs are grouped together based on the same indexed dataset wherein the grouped UEs are considered to have similar dataset characteristics. gNB determines to receive the selective datasets from subset of UEs in each UE groups. The key benefit is the reduction of signaling overhead for dataset transfer through this UE grouping based dataset transfer. UEs in close proximity communicate each other thru sidelink for sharing common dataset generation, whereby for grouped UEs one or a few representative UEs send dataset or subsets

In some embodiments of the method according to the first aspect, the method is characterized by that when grouped UEs one or a few representative UEs send dataset or subsets all UEs do not need to send their own dataset information.

In some embodiments of the method according to the first aspect, the method is characterized by that gNB can group UEs based on location information whereby multicast signaling is used to receive dataset information selectively from UEs and not from all UEs.

According to a second aspect, the present disclosure relates to an apparatus for model dataset signaling for radio access network sending the dataset index or the data subset from the collected dataset for dataset transfer from one node to the other node the apparatus comprising a wireless transceiver, a processor coupled with a memory in which computer program instructions are stored, said instructions being configured to implement steps to any one of the embodiments of the first aspect User Equipment comprising an apparatus any one of the embodiments of the second aspect.

Base station comprising an apparatus any one of the embodiments of the second aspect.

Wireless communication system, wherein the gNB comprises a processor coupled with a memory in which computer program instructions are stored, said instructions being configured to implement steps of the first aspect, wherein the user equipment (UE) comprises a processor coupled with a memory in which computer program instructions are stored, said instructions being configured to implement implement the steps of the first aspect.

### BRIEF DESCRIPTION OF THE DRAWINGS

FIG. 1 is a signaling flow of sending dataset index with associated information.

FIG. 2 is a signaling flow of sending data subset(s) with associated information.

FIG. 3 is an exemplary signaling of dataset transfer using method #1.

FIG. 4 is an exemplary signaling of dataset transfer using method #2.

FIG. 5 is a flow chart of gNB/network side for dataset transfer methods.

FIG. 6 is a flow chart of UE side for dataset transfer methods.

FIG. 7 is an exemplary block diagram of dataset mapping relationship table.

FIG. 8 is an exemplary block diagram of splitting qualified dataset and non-qualified dataset.

FIG. 9 is an exemplary block diagram of mapping of reference datasets with other data values into a finite set of data subsets.

FIG. 10 is a signaling flow of multiple data subsets transfer.

FIG. 11 is a block diagram of dataset-based UE grouping.

FIG. 12 is a signaling flow of UE group-based dataset transfer.

### DETAILED DESCRIPTION OF EXEMPLARY EMBODIMENTS

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate.

Likewise, any advantage of any of the embodiments may apply to any other embodiments, and vice versa. Other aspects, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. Mobile Switching Center (MSC), Mobility Management Entity (MME), etc), Operations & Maintenance (O&M), Operations Support System (OSS), Self Optimized Network (SON), positioning node (e.g. Evolved-Serving Mobile Location Centre (E-SMLC)), Minimization of Drive Tests (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category MI, UE category M2, ProSe UE, V2V UE, V2X UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNodeB (gNB), or UE.

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment. Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the fimctions/acts specified in the flowchart diagrams and/or block diagrams

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements

The description of elements in each figure may refer to elements of proceeding figures. Like numbers refer to like elements in all figures, including alternate embodiments of like elements.

The detailed description set forth below, with reference to the figures, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. For instance, although 3GPP terminology, from e.g., 5G NR, may be used in this disclosure to exemplify embodiments herein, this should not be seen as limiting the scope of the present disclosure.

The disclosure is related to wireless communication system, which may be for example a 5G NR wireless communication system. More specifically, it represents a RAN of the wireless communication system, which is used exchange data with UEs via radio signals. For example, the RAN may send data to the UEs (downlink, DL), for instance data received from a core network (CN). The RAN may also receive data from the UEs (uplink, UL), which data may be forwarded to the CN.

In the examples illustrated, the RAN comprises one base station, BS. Of course, the RAN may comprise more than one BS to increase the coverage of the wireless communication system. Each of these BSs may be referred to as NB, eNodeB (or eNB), gNodeB (or gNB, in the case of a 5G NR wireless communication system), an access point or the like, depending on the wireless communication standard(s) implemented.

The UEs are located in a coverage of the BS. The coverage of the BS corresponds for example to the area in which UEs can decode a PDCCH transmitted by the BS. the present disclosure, performed at a UE corresponds to an apparatus that provides wireless connectivity with the RAN of the wireless communication system, and that can be used to exchange data with said RAN. Such a wireless device may be included in a UE. The UE may for instance be a cellular phone, a wireless modem, a wireless communication device, a handheld device, a laptop computer, or the like. The UE may also be an Internet of Things (IoT) equipment, like a wireless camera, a smart sensor, a smart meter, smart glasses, a vehicle (manned or unmanned), a global positioning system device, etc., or any other equipment that may run applications that need to exchange data with remote recipients, via the wireless device.

The wireless device comprises one or more processors and one or more memories. The one or more processors may include for instance a central processing unit (CPU), a digital signal processor (DSP), a field-programmable gate array (FPGA), an application specific integrated circuit (ASIC), etc. The one or more memories may include any type of computer readable volatile and non-volatile memories (magnetic hard disk, solid-state disk, optical disk, electronic memory, etc.). The one or more memories may store a computer program product, in the form of a set of program-code instructions to be executed by the one or more processors to implement all or part of the steps of a method for exchanging data, performed at a UE's side, according to any one of the embodiments disclosed herein.

The wireless device can comprise also a main radio, MR, unit. The MR unit corresponds to a main wireless communication unit of the wireless device, used for exchanging data with BSs of the RAN using radio signals. The MR unit may implement one or more wireless communication protocols, and may for instance be a 3G, 4G, 5G, NR, WiFi, WiMax, etc. transceiver or the like. In preferred embodiments, the MR unit corresponds to a 5G NR wireless communication unit.

The following explanation will provide the detailed description of the mechanism about pre-configuring and signaling the specific information about mapping relationship information using association between models and other index values for dataset information. AI/ML based techniques are currently applied to many different applications and 3GPP also started to work on its technical investigation to apply to multiple use cases based on the observed potential gains. AI/ML lifecycle can be split into several stages such as data collection/pre-processing, model training, model testing/validation, model deployment/update, model monitoring, model switching/selection etc., where each stage is equally important to achieve target performance with any specific model(s).

In applying AI/ML model for any use case or application, one of the challenging issues is to manage the lifecycle of AI/ML model. It is mainly because the data/model drift occurs during model deployment/inference and it results in performance degradation of AI/ML model. Fundamentally, the dataset statistical changes occur after model is deployed and model inference capability is also impacted with unseen data as input. In a similar aspect, the statistical property of dataset and the relationship between input and output for the trained model can be changed with drift occurrence.

When AI/ML model enabled wireless communication network is deployed, it is then important to consider how to handle AI/ML model dataset transfer under operations such as model training, inference, monitoring, updating, etc. Therefore, a new mechanism about model dataset transmission procedure between gNB and UE is needed to improve signaling overhead with resource efficiency on sharing dataset collection for different model operations.

To reduce signaling overhead due to model dataset transfer, the proposed method is to send the dataset index or the subset from the collected dataset without critical impact on model performance wherein the dataset mapping table is maintained in repository and/or the original dataset collection is divided into multiple subsets based on the measured dataset characteristics.

For dataset transfer, there are two mechanisms as follows (note: both methods can be also combined). For Method #1, the matched dataset index is sent based on the valid dataset mapping table and dataset based mapping relationship information (e.g., mapping tables) are stored in dataset repository in network side and shared with UEs (thru RRC signaling). Then UE generates dataset collection for UE-side model operation. Followingly, UE searches and identifies the specific dataset index matched with the collected dataset. Based on the identified dataset index information, the matched dataset index is sent to gNB for network-side model operation. For Method #2, the prioritized subset of the collected dataset is sent based on the data sample quality and the collected dataset is split into two or more multiple data subsets based on the pre-configured data samples with different quality thresholds wherein data subset(s) selected with target quality is used for UE-side model. Followingly, the same data subset(s) is sent to gNB for network-side model operation.

For both proposed methods above, dataset collection is processed by UE side first. However, the same process can happen when dataset collection is firstly processed by network side.

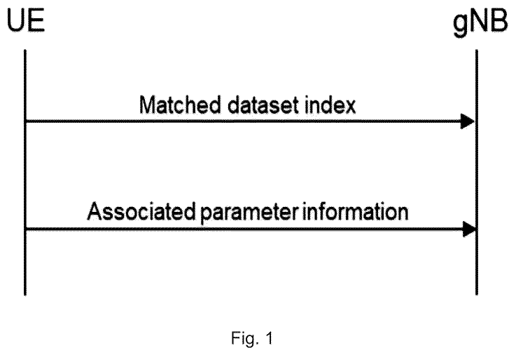

FIG. 1 shows a signaling flow of sending dataset index with associated information. When sending data sample set (e.g., data subset, full dataset, compressed dataset, synthetic data), the associated parameters are sent together. The candidate associated information includes indication of dataset mapping table version, dataset index, statistical characteristic information with data quality threshold level for the selected data subset(s), data subset size index, etc. Depending on dataset transmission methods, any combination of the above associated parameters can be transmitted together. This signaling flow is based on UE-to-gNB and also gNB-to-UE scenario can be considered in a similar way.

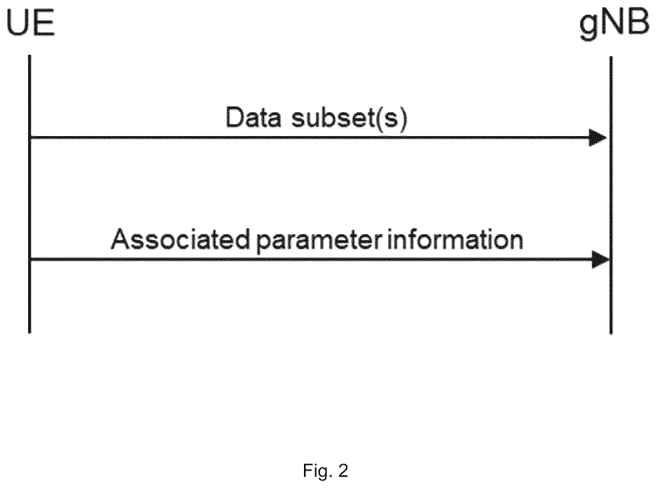

FIG. 2 shows a signaling flow of sending data subset(s) with associated information. As described in the above for FIG. 1, different combinations of associated parameter information can be used for transmission together with data subset(s) such as indication of dataset mapping table version, dataset index, statistical characteristic information with data quality threshold level for the selected data subset(s), data subset size index, etc.

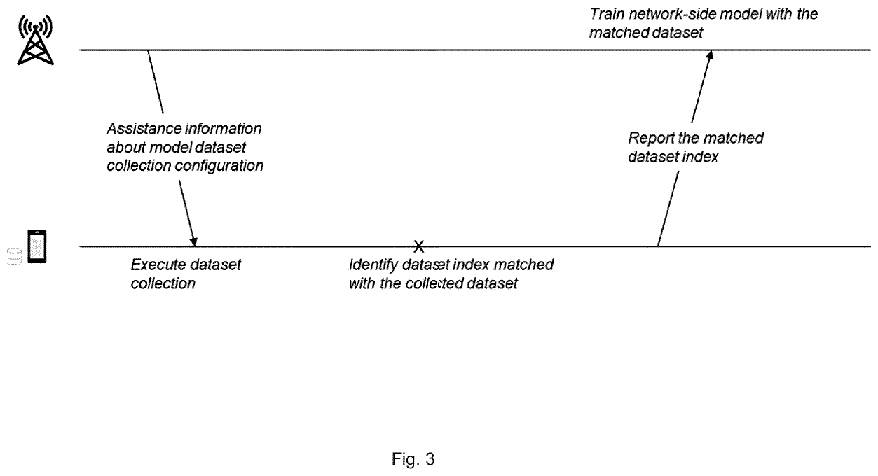

FIG. 3 shows an exemplary signaling of dataset transfer using method #1 related to FIG. 1. For Method #1, the matched dataset index is sent based on the valid dataset mapping table and dataset based mapping relationship information (e.g., mapping tables) are stored in dataset repository in network side and shared with UEs (thru RRC signaling). Then UE generates dataset collection for UE-side model operation. Followingly, UE searches and identifies the specific dataset index matched with the collected dataset. Based on the identified dataset index information, the matched dataset index is sent to gNB for network-side model operation.

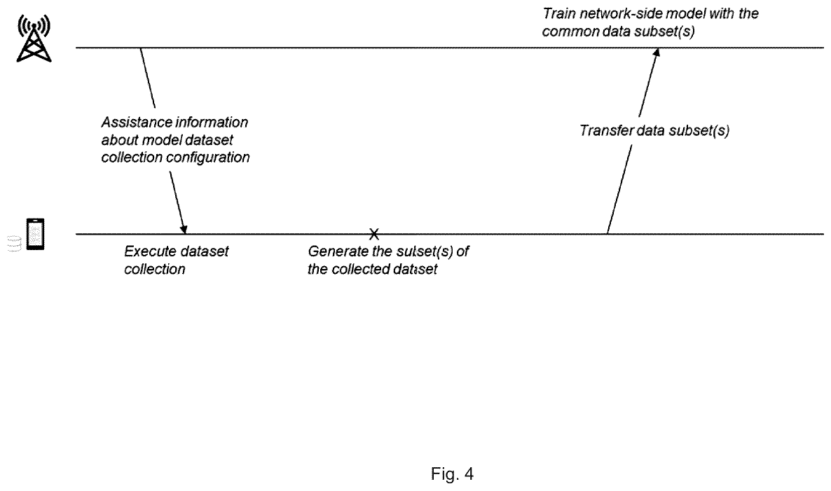

FIG. 4 shows an exemplary signaling of dataset transfer using method #2 related to FIG. 2. For Method #2, the prioritized subset of the collected dataset is sent based on the data sample quality and the collected dataset is split into two or more multiple data subsets based on the pre-configured data samples with different quality thresholds wherein data subset(s) selected with target quality can be used for UE-side model. Followingly, the same data subset(s) is sent to gNB for network-side model operation.

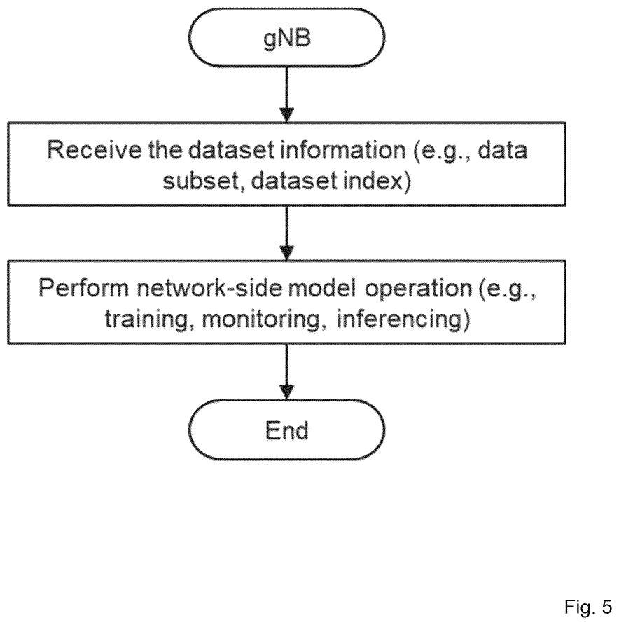

FIG. 5 shows a flow chart of gNB/network side for dataset transfer methods. When dataset collection firstly happens on UE side, gNB receives dataset information such as data subset(s) and/or dataset index depending on dataset transfer methods. After receiving dataset information, network-side model is operated based on the pre-determined model phases such as training, inferencing, monitoring, and/or updating etc.

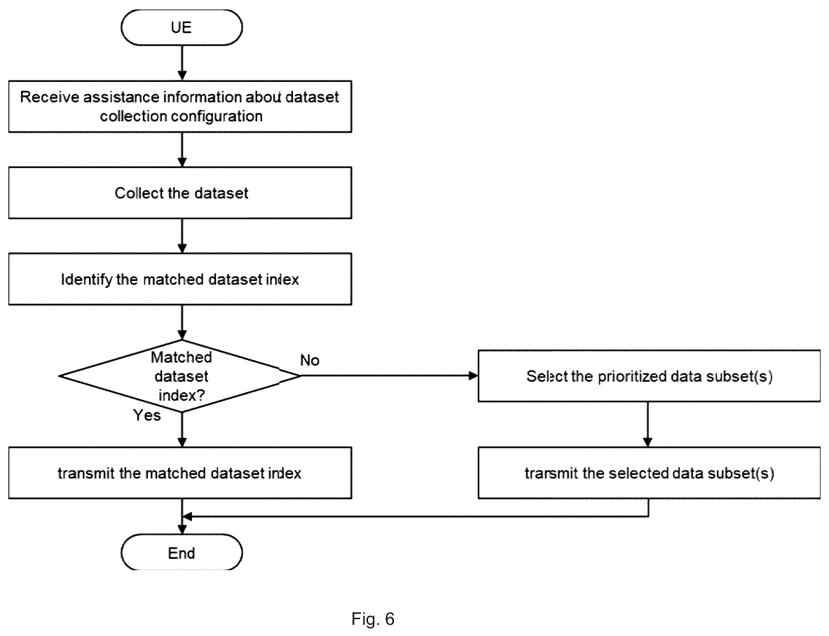

FIG. 6 shows a flow chart of UE side for dataset transfer methods. When dataset collection firstly happens on UE side, UE firstly receives assistance information from gNB about configuration information related to dataset collection. Regarding configuration information, it can include model-specific configuration, dataset characteristics, threshold parameters for dataset collection or subset categorization. If dataset mapping table is available and there is any matched dataset index available compared with the collected dataset, UE can send the index information and/or synthetic data without sending the collected dataset itself. Alternatively, when there is no matched dataset index for selection based on dataset mapping table, UE can select the prioritized data subset from the collected dataset as full set so that signaling overhead can be reduced.

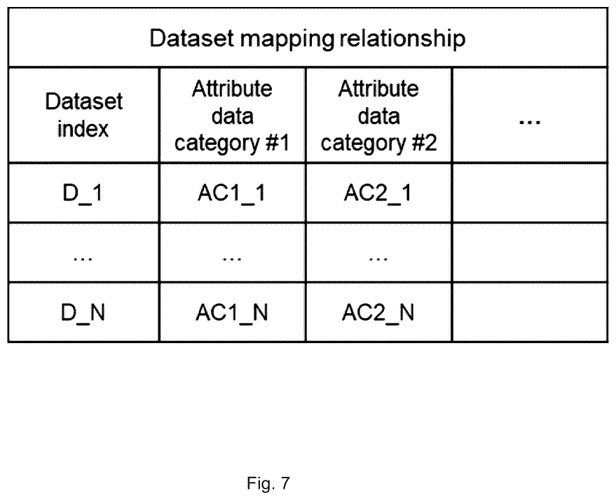

FIG. 7 shows an exemplary block diagram of dataset mapping relationship table. Using different dataset characteristics with associated attribute data categories, dataset can be generated with index values through offline model operation. Depending on different service or applications for AI/ML model use, there can be different number of tables for dataset mapping relationship that can be stored in dataset repository. The associated data content (e.g., attribute data categories) include data characteristics (e.g., statistical information), model configuration (e.g., model type, model parameters), operation environment (e.g., site/time/device information).

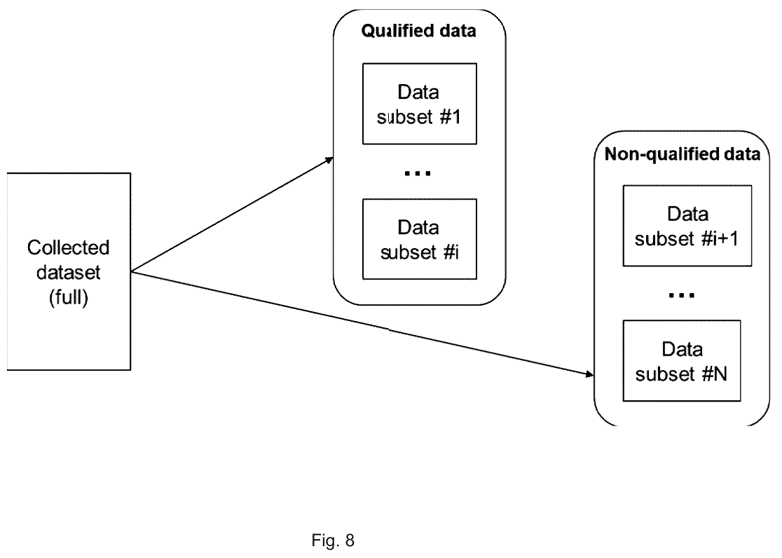

FIG. 8 shows an exemplary block diagram of splitting qualified dataset and non-qualified dataset. For example, outlier data samples are data values with significant differences from the others in dataset and statistical measure using data distribution can be used for data quality estimate. As techniques for data quality measure, K-means algorithm can be one option for use of distance measure to partition the dataset into clusters. Using each clusters with statistical attribute values of all training instances, data samples are assigned to different clusters by applying the distance function to match instances against cluster centers. According to AI/ML study, the collected dataset is often of low quality, i.e., it contains redundant and non-informative data, and often suffers from problems such as noisy labels, distribution mismatch etc. The increment in sample size increases the accuracy of prediction but may not cause a significant change after a certain sample size. Data quality significantly improves the performance and contribute to using small sample sizes. A small sample can be sufficient when dataset has some level of quality data. By sorting out data subset(s) matched with target sample quality, the full set of the collected dataset can be divided into qualified dataset and non-qualified dataset based on the existing data quality measure techniques and target quality threshold is used for ML operation-specific requirement related to different implementation use cases.

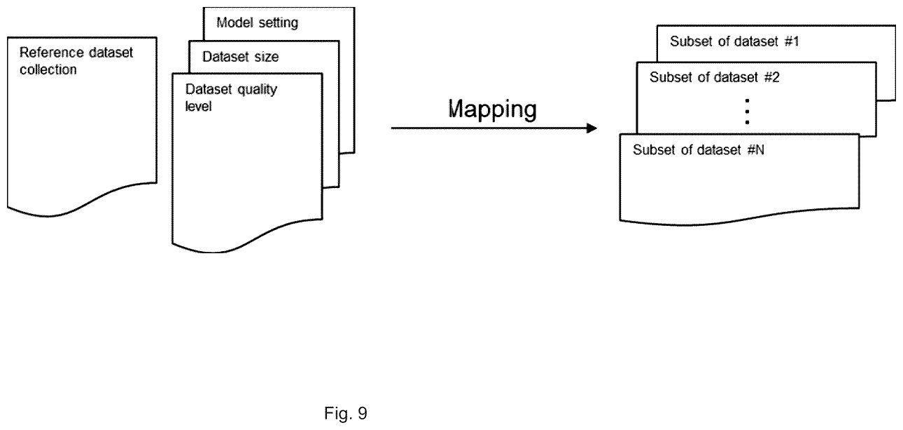

FIG. 9 shows an exemplary block diagram of mapping of reference datasets with other data values into a finite set of data subsets. Based on the collected dataset, mapping relationship of quality-based dataset index is generated. For example, mapping table is one possible way to maintain any available updates related to the associated data values. Multiple mapping tables can be managed through repository for different model use cases based on online/offline and/or LCM phases (training, inferencing, monitoring).

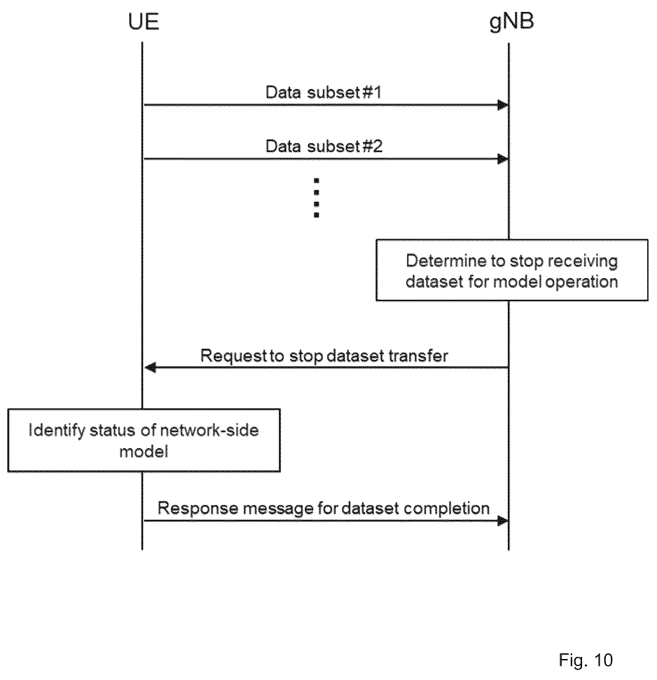

FIG. 10 shows a signaling flow of multiple data subsets transfer. In this example, multiple data subsets are transmitted until there is request message to stop sending dataset. Based on model operation status with the received data subsets, request message to stop sending dataset is sent and the associated model status information is sent together. Response message to confirm dataset transfer completion is sent back. This signaling flow can happen for UE-to-gNB and gNB-to-UE scenarios.

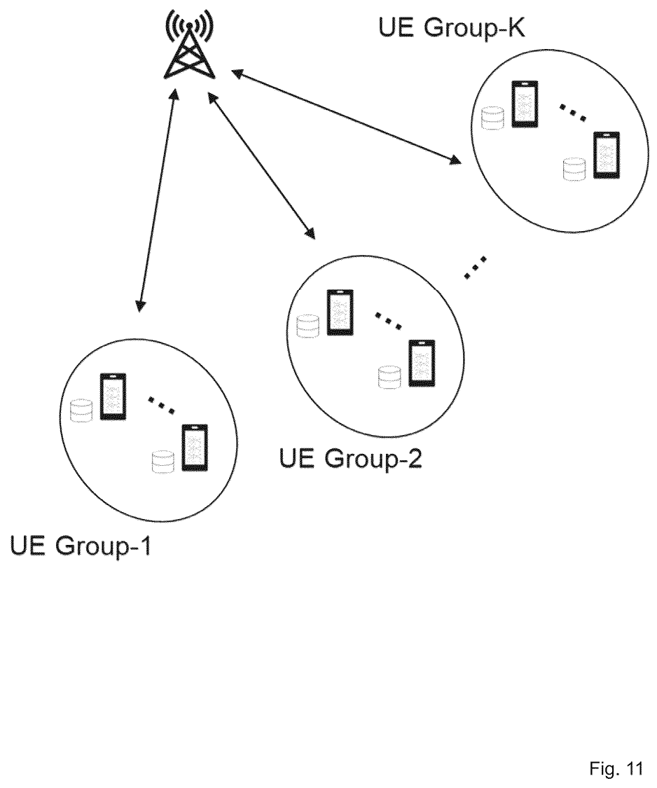

FIG. 11 shows a block diagram of dataset-based UE grouping. gNB collects the indexed value of dataset (subset) from UEs using statistical information of dataset. UEs are grouped together based on the same indexed dataset wherein the grouped UEs are considered to have similar dataset characteristics. gNB determines to receive the selective datasets from subset of UEs in each UE groups. The key benefit is the reduction of signaling overhead for dataset transfer through this UE grouping based dataset transfer.

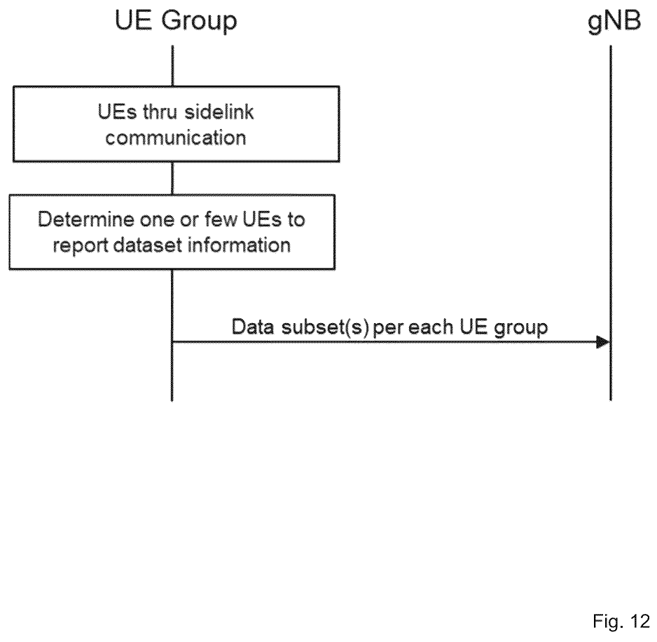

FIG. 12 shows a signaling flow of UE group-based dataset transfer. UEs in close proximity communicate each other thru sidelink for sharing common dataset generation. For grouped UEs, one or a few representative UEs send dataset or subsets. And in this case, all UEs do not need to send their own dataset information. Alternatively, gNB can also group UEs based on location information so that multicast signaling is used to receive dataset information selectively from UEs, not from all UEs.

The proposed scheme shows enhancements for model performance. When dataset is transferred between network and UE for model operation, signaling overhead is quite critical to support dataset sharing between nodes. In this case, the proposed method can reduce signaling overhead due to dataset transfer by selecting subset of dataset collection based on target data quality level. When multiple UEs are communicated with network for two-sided model operation, UE grouping having the common dataset index with specific target data quality level can also reduce signaling overhead by collecting finite number of datasets of UEs from each UE groups rather than collecting all datasets from all UEs.

1. A method of model dataset signaling for radio access network sending the dataset index or the data subset from the collected dataset for dataset transfer from one node to the other node, where the matched dataset index is sent based on the valid dataset mapping table the following steps are performed:
Dataset based mapping relationship information are stored in dataset repository in network side and shared with UEs;
UE generates dataset collection for UE-side model operation;
UE searches and identifies the specific dataset index matched with the collected dataset;
The matched dataset index is sent to gNB for network-side model operation.
The prioritized subset of the collected dataset is sent based on the data sample quality, whereby
the collected dataset is split into two or more multiple data subsets based on the pre-configured data samples with different quality thresholds;
Data subset(s) selected with target quality is used for UE-side model;
the same data subset(s) is sent to gNB for network-side model operation;
Dataset collection is processed by UE side first, wherein the method can happen when dataset collection is firstly processed by network side.

2. The method according to claim 1, wherein dataset based mapping relationship information is a mapping tables which are stored in dataset repository in network side and shared with UEs through RRC signaling.

3. The method according to claim 1, wherein the associated parameters are sent together when sending data sample set where
the candidate associated information includes indication of dataset mapping table version, dataset index, statistical characteristic information with data quality threshold level for the selected data subset(s), data subset size index, etc.
depending on dataset transmission methods, any combination of the associated parameters are transmitted together, whereby this signaling flow is based on UE-to-gNB and also gNB-to-UE is done in a similar way.

4. The method according to claim 1, wherein the data sample set is a data subset, and/or full dataset and/or compressed dataset and/or synthetic data.

5. The method according to claim 1, wherein UE firstly receives assistance information from gNB about configuration information related to dataset collection when dataset collection firstly happens on UE side where
Regarding configuration information, it can include model-specific configuration, dataset characteristics, threshold parameters for dataset collection or subset categorization;
If dataset mapping table is available and there is any matched dataset index available compared with the collected dataset, UE can send the index information and/or synthetic data without sending the collected dataset itself;
Alternatively, when there is no matched dataset index for selection based on dataset mapping table, UE can select the prioritized data subset from the collected dataset as full set so that signaling overhead can be reduced.

6. The method according to claim 1, wherein using different dataset characteristics with associated attribute data categories, dataset can be generated with index values through offline model operation where
Depending on different service or applications for AI/ML model use, there can be different number of tables for dataset mapping relationship that can be stored in dataset repository;
The associated data content (e.g., attribute data categories) include data characteristics (e.g., statistical information), model configuration (e.g., model type, model parameters), operation environment (e.g., site/time/device information).

7. The method according to claim 1, wherein by sorting out data subset(s) matched with target sample quality, the full set of the collected dataset can be divided into qualified dataset and non-qualified dataset based on the pre-configured data quality measure with target quality threshold for ML operation-specific requirement related to different implementation use cases.

8. The method according to claim 1, wherein mapping of reference datasets with other data values is into a finite set of data subsets where
Based on the collected dataset, mapping relationship of quality-based dataset index is generated;
Multiple mapping tables can be managed through repository for different model use cases based on online/offline and/or LCM phases (training, inferencing, monitoring).

9. The method according to claim 1, wherein multiple data subsets transfer where
Multiple data subsets are transmitted until there is request message to stop sending dataset;
Based on model operation status with the received data subsets, request message to stop sending dataset is sent and the associated model status information is sent together. Response message to confirm dataset transfer completion is sent back.

10. The method according to claim 1, wherein dataset-based UE grouping. gNB collects the indexed value of dataset (subset) from UEs using statistical information of dataset where
UEs are grouped together based on the same indexed dataset wherein the grouped UEs are considered to have similar dataset characteristics;
gNB determines to receive the selective datasets from subset of UEs in each UE groups;
UEs in close proximity communicate each other thru sidelink for sharing common dataset generation, whereby for grouped UEs one or a few representative UEs send dataset or subsets

11. The method according claim 10, wherein when grouped UEs one or a few representative UEs send dataset or subsets all UEs do not need to send their own dataset information.

12. The method according claim 10, wherein gNB can group UEs based on location information whereby multicast signaling is used to receive dataset information selectively from UEs and not from all UEs.

13. Apparatus for QoS specific configured grant based small data transmission, the apparatus comprising a wireless transceiver, a processor coupled with a memory in which computer program instructions are stored, said instructions being configured to implement the method of claim 1.

14. A User Equipment comprising an apparatus according to claim 13.

15. A base station comprising an apparatus according to claim 13

16. A wireless communication system, comprising a gNB and a User Equipment,
wherein the gNB comprises a processor coupled with a memory in which computer program instructions are stored,
wherein the user equipment (UE) comprises a processor coupled with a memory in which computer program instructions are stored,
wherein said instructions computer program in each of the gNB and the UE are configured to implement the method of claim 1.
